(19) United States
(12) Patent Application Publication
(10) Pub. No.: US 2023/0187772 A1
(43) Pub. Date: Jun. 15, 2023

(54) BATTERY FOR A DRIVE OF A MOTOR VEHICLE

(71) Applicant: Dr. Ing. h.c. F. Porsche Aktiengesellschaft, Stuttgart (DE)

(72) Inventors: Daniel Fink, Ludwigsburg (DE); Ralf Keller, Pforzheim (DE); Maximilian Müller, Leonberg (DE)

(73) Assignee: Dr. Ing. h.c. F. Porsche Aktiengesellschaft, Stuttgart (DE)

(21) Appl. No.: 18/078,180

(22) Filed: Dec. 9, 2022

(30) Foreign Application Priority Data
Dec. 10, 2021 (DE) 10 2021 132 620.6

(51) Int. Cl. H01M 50/342; H01M 50/30; H01M 50/60

(52) U.S. Cl. CPC H01M 50/3425; H01M 50/394; H01M 50/668; H01M 2220/20

(57) ABSTRACT

A battery for a drive of a motor vehicle includes at least one energy reservoir, a housing, an interior, and a diffuser element. The housing surrounds the interior and the energy reservoir is arranged in the interior. The diffuser element is attached to an exterior of the housing. The diffuser element includes a plurality of diffuser outlets, a plurality of side faces, and a head face. The side faces are arranged between the housing and the head face. A housing outlet is arranged in the housing, which outlet is configured so as to discharge gas out of the interior in an outgoing direction to the diffuser element. The outgoing direction is directed from the housing outlet towards the head face. The diffuser outlets are arranged on the side faces.

### CROSS-REFERENCE TO RELATED APPLICATION

This application claims priority to German Patent Application No. 10 2021 132 620.6, filed Dec. 10, 2021, the content of such application being incorporated by reference herein in its entirety.

### FIELD OF THE INVENTION

The present invention relates to a battery for a drive of a motor vehicle.

### BACKGROUND OF THE INVENTION

The present invention relates to a battery for a drive of a motor vehicle. During operation, the drive is supplied with electrical power from the battery. Gases can be generated in the interior of the battery, which must be discharged in order to avoid excessive pressure in the interior. U.S. Pat. No. 5,643,691 A, which is incorporated herein by reference, discloses a battery having a dispersion apparatus at a gas outlet.

### SUMMARY OF THE INVENTION

It would be desirable to reduce the risk of undesirable ignitions of gas leaking from the battery.

The battery described herein is configured so as to propel a motor vehicle and can be configured, for example, as a high-voltage battery. The battery comprises at least one energy reservoir, a housing, an interior, and a diffuser element. For example, electrochemical energy can be stored in the energy reservoir. The housing surrounds the interior. The energy reservoir unit is arranged in the interior. The diffuser element is attached to an exterior of the housing. In the context of this description, the exterior is understood to mean, in particular, a surface that is accessible from the outside of the interior. The diffuser element is thus arranged outside the interior.

The diffuser element includes a plurality of diffuser outlets, a plurality of side faces, and a head face. The side faces are arranged between the housing and the head face. For example, the head face can be directly connected to all side faces.

A housing outlet is arranged in the housing and is configured so as to output gas from the interior, which can be produced during operation of the battery, in an outgoing direction towards the diffuser element. The outgoing direction is directed from the housing outlet towards the head face. The diffuser outlets are arranged on the side faces. It is possible, in particular, that the diffuser outlets are arranged exclusively on the side faces, and thus the head face is free of diffuser outlets. In order for the gas to be able to flow into the diffuser element through the housing outlet, the diffuser element can have an opening arranged opposite the head face and thus adjacent to the housing outlet.

Due to the arrangement of the diffuser outlets on the side faces, the gas flowing out of the interior is redirected in a plurality of directions before it reaches the environment. As a result, the gas is better distributed in the environment, so that the risk of high concentrations of the gas is reduced. This reduces the risk of undesirable ignitions of the gas.

According to one embodiment of the invention, the head face can be free of holes. This ensures that the gas flows through the diffuser outlets on the side faces.

According to one embodiment of the invention, the diffuser outlets can be slot-shaped. In particular, within the context of this description, this means that the diffuser outlets in a first direction have an extension that exceeds by more than five times the extension in a second direction that runs perpendicular to the first direction. Preferably, the first direction runs from the exterior of the housing to the head face.

According to one embodiment of the invention, the distance between the housing and the head face can be more than 50 millimeters. This leads to a particularly good distribution of the gas to the diffuser outlets.

According to one embodiment of the invention, the diffuser outlets can be arranged on oppositely arranged side faces. This further improves the distribution of the gas in the environment. The side faces arranged opposite one another can be, for example, not adjacent to one another and thus not in direct contact with one another.

According to one embodiment of the invention, each of the side faces can comprise a plurality of diffuser outlets.

According to one embodiment of the invention, the diffuser element can be configured so as to redirect the gas flowing out in the outgoing direction and deliver it through the diffuser outlets to an ambient environment of the battery. The redirection can occur, for example, by an angle of between 80° and 100°.

According to one embodiment of the invention, the battery can comprise a valve element arranged on the housing outlet. In the context of this description, a valve element is in particular understood to mean an element that allows gas to exit out of the interior, whereas it prevents the penetration of a fluid into the interior. For example, the gas can flow out of the interior through the valve element in the direction of the head face. The valve element can be configured so as to permanently release the housing outlet as soon as the pressure of the gas in the interior exceeds a threshold. In particular, this means that the housing outlet also remains released when there is no pressure difference between the interior and the surrounding environment. For example, this can be referred to as a burst function. In this way, it can be prevented that too much pressure is produced in the interior if the valve element malfunctions, which can damage the battery or even lead to an explosion.

According to one embodiment of the invention, the battery can comprise a seal. The seal can separate the diffuser element from the interior in a water-tight manner.

The motor vehicle comprises a battery according to an embodiment of the invention and a drive electrically connected to the battery, which is configured so as to cause a movement of the entire motor vehicle.

### BRIEF DESCRIPTION OF THE DRAWING FIGURES

Further features and advantages of the present invention will become apparent from the following description of preferred design examples with reference to the accompanying figures. The same reference numbers are used for the same or similar features and for features having the same or similar functions. Here:

FIG. 1 shows a schematic sectional view of a section of a battery according to an embodiment of the invention;

FIG. 2 shows a schematic perspective view of a battery from the prior art without the diffuser element;

FIG. 3 shows a schematic perspective view of a battery according to an embodiment of the invention; and

FIG. 4 shows a schematic perspective view of the battery from FIG. 3 in a motor vehicle.

### DETAILED DESCRIPTION OF THE INVENTION

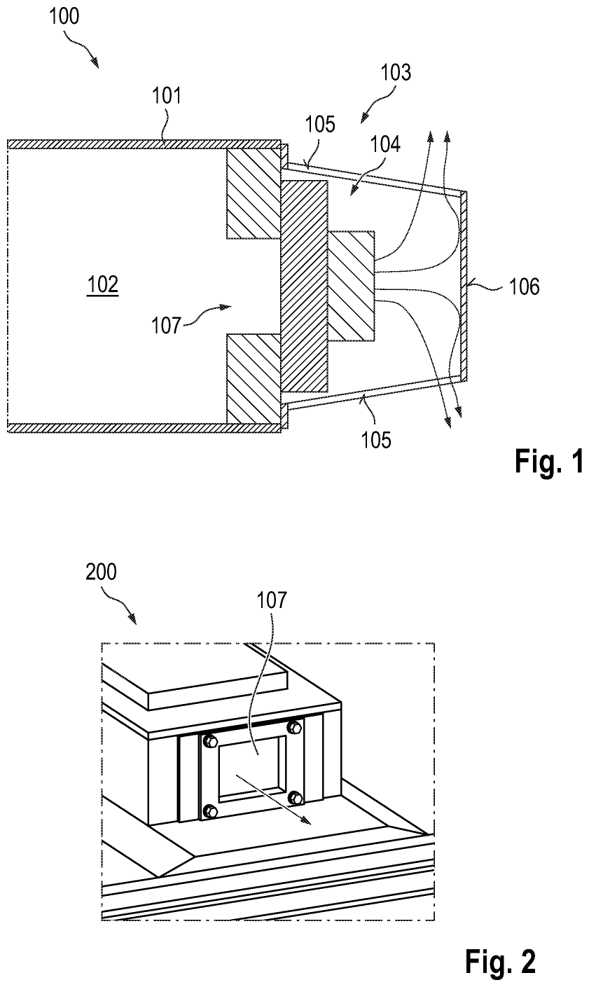

Turning now to FIGS. 1-4, the battery 100 comprises a housing 101 that surrounds an interior 102. An energy reservoir (not shown in the figures) is arranged in the interior 102. Gas produced during operation of the battery 100 can flow out of the interior through a housing outlet 107. The outgoing gas is represented by arrows in the figures. A valve element 104 is arranged directly on the housing outlet 107, through which the gas can flow. In particular, the valve element 104 prevents moisture and/or other fluids from entering the interior 102.

The valve element 104 is also configured so as to permanently release the housing outlet 107 when the pressure of the gas in the interior 102 exceeds a threshold. For example, in this case, a portion of the valve element 104 can break out.

A diffuser element 103 having four side faces 105 and a head face 106 is attached to an exterior of the housing 101. Slot-shaped diffuser outlets 300 are arranged on all four side faces 105, through which the gas can flow into an environment. Because the head face 106 is free of diffuser outlets, the gas flowing out of the interior 101 towards the head face 106 is redirected towards the side faces 105 and exits to the environment through the diffuser outlets 300.

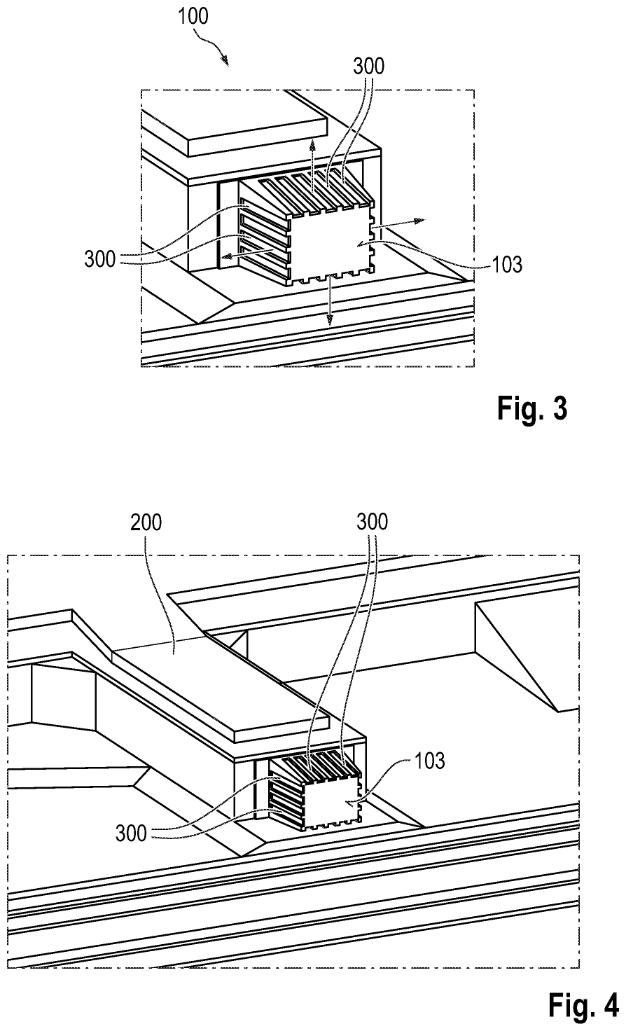

By redirecting the gas and dividing the gas flow into different directions, the concentration of the gas in the immediate vicinity of the battery 100 is reduced so that an undesirable ignition is less likely. This becomes particularly clear from a comparative consideration of the battery 200 from FIG. 2 and the battery 100 from FIG. 3. No diffuser element 103 is present in the battery 200. The gas flows into the environment in a single direction at high concentration. With the battery 100, on the other hand, the gas flows in different directions and thus also at lower concentrations through the diffuser outlets 300 at the side faces 105 of the diffuser element 103.

What is claimed:

1. A battery for a drive of a motor vehicle, said battery comprising:
at least one energy reservoir;
a housing defining an interior, wherein the housing surrounds the interior and the energy reservoir is arranged in the interior; and
a diffuser element including a plurality of diffuser outlets, a plurality of side faces, and a head face, wherein the side faces are arranged between the housing and the head face,
wherein the diffuser element is attached to an exterior of the housing,
wherein a housing outlet is arranged in the housing, which outlet is configured so as to discharge gas out of the interior in an outgoing direction to the diffuser element,
wherein the outgoing direction is directed from the housing outlet towards the head face, and
wherein the diffuser outlets are arranged on the side faces.

2. The battery according to claim 1, wherein the head face is devoid of holes.

3. The battery according to claim 1, wherein the diffuser outlets are slot-shaped.

4. The battery according to claim 1, wherein a distance between the housing and the head face is more than 50 millimeters.

5. The battery according to claim 1, wherein the diffuser outlets are arranged on oppositely arranged side faces.

6. The battery according to claim 1, wherein each of the side faces comprises a plurality of diffuser outlets.

7. The battery according to claim 1, wherein the diffuser element is configured so as to redirect the gas flowing out in the outgoing direction and deliver the gas through the diffuser outlets to an ambient environment of the battery.

8. The battery according to claim 1, wherein the battery comprises a valve element arranged adjacent the housing outlet, wherein the valve element is configured to permanently release the housing outlet as soon as a pressure of a gas in the interior exceeds a threshold.

9. The battery according to claim 1, wherein the battery comprises a seal that separates the diffuser element from the interior in a water-tight manner.

10. A motor vehicle comprising (i) the battery according to claim 1 and (ii) the drive, wherein the battery is electrically connected to the drive, wherein the drive is configured so as to cause a movement of the motor vehicle.
